(19) United States
(12) Patent Application Publication
(10) Pub. No.: US 2003/0110252 A1
(43) Pub. Date: Jun. 12, 2003

(54) Enhanced system and method for network usage monitoring

(76) Inventor: Siew-Hong Yang-Huffman, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/012,713

(22) Filed: Dec. 7, 2001

(51) Int. Cl. G06F 15/173

(52) U.S. Cl. 709/224; 709/223

(57) ABSTRACT

A system and method for the collection of usage data from at least one node of a network is provided. In one embodiment, the present invention includes a computer program product having a computer readable medium having computer logic recorded thereon for the collection of usage data from at least one node of a network. The computer program product preferably includes code for receiving data from an administrative application, wherein such data identifies at least one node of a network. In addition, the computer program product includes code for configuring the computer program product to collect usage data from at least one of the one or more identified network nodes.

### RELATED APPLICATIONS

This application relates to co-pending, concurrently filed, and commonly assigned United States patent application, application Ser. No. ______ [Attorney Docket No. 10012516-1] entitled “SYSTEM AND METHOD FOR NETWORK USAGE METERING” filed [filing date to be entered], the disclosure of which is hereby incorporated herein by reference. This patent application is also related to the following co-pending and commonly assigned U.S. patent application Ser. No. 09/559,438 entitled “INTERNET USAGE DATA RECORDING SYSTEM AND METHOD EMPLOYING BATCH CORRELATION OF INDEPENDENT DATA SOURCES”; Ser. No. 09/560,509 entitled “INTERNET USAGE DATA RECORDING SYSTEM AND METHOD WITH CONFIGURABLE DATA COLLECTOR SYSTEM”; Ser. No. 09/559,693, entitled “INTERNET USAGE DATA RECORDING SYSTEM AND METHOD EMPLOYING DISTRIBUTED DATA PROCESSING AND DATA STORAGE”; and Ser. No. 09/560,032, entitled “INTERNET USAGE DATA RECORDING SYSTEM AND METHOD EMPLOYING A CONFIGURABLE RULE ENGINE FOR THE PROCESSING AND CORRELATION OF NETWORK DATA”, which were all filed on Apr. 27, 2000, and are all hereby incorporated herein by reference. This application is further related to the following co-pending and commonly assigned U.S. patent application Ser. No. 09/578,826, entitled “INTERNET USAGE DATA RECORDING SYSTEM AND METHOD EMPLOYING A CONFIGURABLE RULE ENGINE WITH IP ADDRESS RANGE MATCHING FOR THE PROCESSING OF NETWORK DATA”, filed May 24, 2000, the disclosure of which is hereby incorporated herein by reference.

### TECHNICAL FIELD

The present invention relates to network administration systems, and in one aspect to an enhanced system and method for network usage monitoring.

### BACKGROUND OF THE INVENTION

Today's Internet business market is extremely competitive with few barriers to entry. An Internet business' chances for success in this competitive market are heavily dependent upon its ability to understand its customers' needs and demands and quickly deploy new services and/or products that meet those needs. In addition, the increasing use of services over the Internet and the increasing variety of such services presents a need for a provider of such services to have an effective mechanism for metering and billing for consumption of such services. Such diverse features as text, audio files, video files, and photographs, lead to variations in the quantities of data consumed by different customers employing the same or similar Internet connection mechanisms. It is therefore desirable to keep track of the level of service consumed by individual customers. Similarly, in some circumstances, it is desirable for an Internet business to charge customers based on usage of services, rather than charging a flat fee (e.g., a set monthly fee). As a resource in understanding customers' needs and demands and/or as a mechanism for metering consumption of services, network usage monitoring systems have been developed (e.g., Hewlett Packard's Internet Usage Manager®).

Network usage monitoring systems, in at least some instances, allow Internet businesses (e.g., an Internet Service Provider (ISP)) to effectively collect and analyze data on how their customers are using valuable company network resources. One existing network usage monitoring system is a network use mediation mechanism that gathers usage information from network devices such as routers, ATM switches, Web servers, mails servers, VOIP (Voice Over Internet Protocol) and wireless gateways and filters and combines that information based on customer site needs, and then makes that information easily available to an application(s) through file based or programmatic (API) means (e.g., Hewlett Packard's Internet Usage Manager®). Applications that may be built on top of such network usage monitoring systems include billing, capacity planning, fraud detection, and marketing analysis.

In some instances, network usage monitoring systems employ Simple Network Management Protocol (SNMP) to gather information from network devices. SNMP is a set of widely used standards for multi-vendor, interoperable network management. The SNMP protocol is commonly used for network managers to manage and exchange information with their agents. Network management information for an agent is typically stored in a database called a Management Information Base (MIB) that consists of a set of objects.

In the context of MIBs, an object typically represents a resource, an activity, or other related information to be managed. A network management entity can monitor the resources of a system by reading the values of objects in the MIB and may control the resources at that system by modifying those objects.

The objects of the MIB are normally arranged in a hierarchical or tree structure. The “leaf” objects of the tree are usually the actual managed objects, each of which represents some resource, activity, or related information to be managed. The tree structure itself defines a grouping of objects into a logically related set. Each object in the tree is generally associated with a unique identifier and generally consists of a sequence of integers such as, for instance, 1.3.1.6.1.2.1.1.3 (representing iso.org.dod.internet.mgmt.mib2.system.sysuptime). This unique identification is called an Object Identifier (OID). In the foregoing, “iso” stands for “International Organizations for Standards”; “org” stands for “organization”; “dod” stands for “Department of Defense”; “mgmt” stands for “management”; “mib2” stands for “management information base 2”; and “sysuptime” stands for “system up time” which is the elapsed time to any given moment from the point in time where the system was last initialized.

Information is generally exchanged between a manager and an agent in the form of an SNMP message which usually specifies an SNMP-Get or SNMP-Set operation. A network manager may monitor an agent by retrieving the values of some objects in the agent's MIB using an SNMP-Get or SNMP-GetNext operation and may control that agent by modifying those values though an SNMP-Set operation.

An SNMP-Get operation is generally a command to retrieve information concerning an object or row entry in a MIB table. An SNMP Set operation is generally a command which assigns values to an object or row entry in a MIB table. An SNMP GetNext operation is generally a command to retrieve information regarding a row in a MIB table which immediately succeeds a row identified by a particular OID.

Generally, SNMP operations involve access to an object in a MIB. To facilitate multiple-object exchanges, SNMP messages generally include a “variable bindings” field. This field generally consists of a sequence of references of object instances, together with the values of those objects. When a MIB object is a table containing multiple rows, an SNMP-GetNext operation is usually used to scan the table in order to find the value of the object instance that occurs next in the table according to the previously referenced sequence of references.

For additional information on SNMP, MIBs, etc., see “SNMP, SNMPv2, SNMPv3 and RMON1 and 2 (3rd edition)” by William Stallings, the contents of which are hereby incorporated herein by reference.

Presently, before a network usage monitoring system is able to gather data from a particular network device, a user (e.g., a system administrator) must configure the monitoring system to collect data from that particular device. This is true for all network devices the user desires the monitoring system to gather data from. Configuring the system to each particular device is a burdensome process that consumes a substantial amount of time and resources.

### SUMMARY OF THE INVENTION

The present invention is directed to a system and method for the collection of usage data from at least one node of a network. In one embodiment, the present invention includes a computer program product having a computer readable medium having computer logic recorded thereon for the collection of usage data from at least one node of a network. The computer program product preferably includes code for receiving data from an administrative application, wherein such data identifies at least one node of a network. In addition, the computer program product includes code for configuring the computer program product to collect usage data from at least one of the one or more identified network nodes.

### BRIEF DESCRIPTION OF THE DRAWINGS

FIG. 1 depicts a block diagram of an exemplary network including an exemplary embodiment of an enhanced network usage monitoring system in accordance with the present invention;

FIG. 2 depicts a block diagram of an exemplary processor-based device;

FIG. 3 depicts an exemplary flow diagram illustrating the operation of an embodiment of an enhanced network usage monitoring application;

FIG. 4 depicts an exemplary agent object class with attributes in accordance with the present invention;

FIG. 5 depicts an exemplary collector;

FIG. 6 depicts the exemplary network of FIG. 1 after an embodiment of the network usage monitoring system has configured itself to collect data from network data sources; and

FIG. 7 depicts the exemplary network of FIG. 1 after another embodiment of the network usage monitoring system has configured itself to collect data from network data sources.

### DETAILED DESCRIPTION OF THE INVENTION

FIG. 1 depicts an exemplary network 100 that includes an embodiment of a network usage monitoring system in accordance with the present invention. In particular, FIG. 1 depicts exemplary network 100 prior to certain operations of enhanced network usage monitoring application 120 (to be discussed in greater detail below). Network 100 may be any one or a combination of numerous known data networks, or a portion thereof, to include a local area network (LAN), a metropolitan area network (MAN), a wide area network (WAN), an Ethernet network, a fibre channel network, an Intranet, ATM (asynchronous transfer mode) network, IP (Internet Protocol) network, the Internet, etc. Moreover, network 100 may be implemented utilizing any number of communication mediums and protocols, wireline and/or wireless.

Network 100 includes one or more usage data sources represented in FIG. 1 by usage data sources 110-1, 110-2, and 110-n. Usage data sources 110-1, 110-2, and 110-nmay be any sub-network, network device, and/or application(s) residing thereon, from which network usage information may be gathered. “Network usage” for purposes of this disclosure generally corresponds to a quantity of service, such as data acquisition, provided to a customer over a data network. Network usage may include, but is not limited to, acquisition of data, over a network, in the form of text data, image data, audio data, and/or video data. Network usage may also correspond to an amount of reserved bandwidth, the directness and/or speed of one or more communication paths, the quality of service of a customer's data network connection, a number of messages transmitted and/or received, a measure of processing effort expended by a computer on a node remote from a particular user site on a network, such as for searching purposes, a number of data records searched through, or a combination of any of the foregoing. The particular usage data gathered from the usage data sources may include such metrics as traffic at a device, the number of bytes and/or packets transferred, the number of bytes stored, the date and/or time of transfer, the date and/or time of storage, the category of data (e.g., audio/video data), start time, end time, source address(es), destination address(es), the applications to which bytes and/or packets relate, service or end-applications accessed, number of services used, quality of service level, port number(s), protocol(s), line and/or port status information, resolution information, subscriber class membership information, non-traffic based resource information, bandwidth consumption information, login session information, and/or the like.

Non-limiting examples of usage data sources that may be included in network 100 include bridges, routers, hubs, switches, gateways, probes, repeaters, server devices (e.g., web servers, news servers, mail servers, VOIP (Voice Over Internet Protocol) servers, VPN (Very Private Network) servers), client devices, host devices, peripheral devices, access systems, IP (Internet Protocol) infrastructure devices, ATM (asynchronous transfer mode) infrastructure devices, and/or the like. As mentioned, in one embodiment, one or more data sources of network 100 are sub-networks.

In a preferred embodiment, one or more of data sources 110-1, 110-2, and 110-n include a source agent (e.g., a network management agent such as a simple network management protocol (SNMP) agent, a common management information protocol (CMIP) agent, and/or the like), as well as a source database associated with (e.g., included as part of) the source agent (e.g., an SNMP agent's corresponding management information base (MIB)). For example, in FIG. 1, data source 110-1 includes source agent 160-1 and associated source database 165-1. Similarly, data source 110-2 includes source agent 160-2 and associated source database 165-2. Furthermore, data source 10-n includes source agent 160-n and associated source database 165-n.

A source agent, for purposes of this disclosure, is a software module residing on a usage data source that is responsible for maintaining local management information and delivering that information to one or more applications. In operation, the source agent is typically configured to gather certain information (e.g., network-related information) from the host device. In one embodiment, such information includes the usage data described above. In some embodiments, the source agent populates its associated database (e.g., populate its MIB tables) with the gathered information so that the information may be consumed by one or more applications. The database associated with a source agent (e.g., the MIB tables) can be used to store more than usage information. For example, the MIB tables may contain service assurance data (e.g., number/average-number of errors/dropped packets encountered in a specific time period), network identification (e.g., assigned name of a device), connections (the other devices connected to the host device), etc. In one embodiment, the data is populated in the MIB table(s) via one or more objects. Preferably, each MIB object itself defines what kind of information is to be stored and for what purpose, and each source agent is configured to populate certain MIB objects only when active. The process by which each source agent gathers and stores information, as well as how the source agent communicates that information to other applications, normally depends upon the underlying hardware and embedded technology.

Also preferably included in network 100 is network topology application 140, as well as one or more other administrative applications (represented in FIG. 1 by other administrative applications 150-1 and 150-n). The administrative applications of network 100 may include a range of business intelligence, marketing, operations management, and/or network management applications, such as billing applications, legacy system applications, strategic marketing applications, capacity planning applications, security applications, fraud management applications, service level agreement applications, fault management applications (e.g., Hewlett Packard's Vantage Point Operation® (VPO) software), business planning applications (e.g., Hewlett Packard's Dynamic NetValue Analyzer® (DNA) software) and/or the like.

In one embodiment, network topology application 140 stores a snapshot of the current topology of network 100 by storing information about network nodes discovered during a device discovery procedure such as a polling period (e.g., information about discovered network devices and/or sub-networks) into a network map file. Preferably, the network map file is a hierarchical structure that describes the network from WAN to LAN to sub-network, etc., all the way down to the device level. Furthermore, preferably, the data included in the network map file is such that when application 120 (discussed in detail below) reads the map file, application 120 is able to determine the end nodes (e.g., network devices and/or sub-networks) of the network. For instance, the information stored in the network map file preferably includes information indicating the end nodes of the network (e.g., the “Object Type: 4” string used by Hewlett Packard's Network Node Manager®), as well as the IP addresses or domain names of the end nodes. In addition, in one embodiment, the information contained in the network map file includes host name(s) for the discovered network device(s), object type, and the like. Furthermore, the information stored in the network map file may also include symbol (typically the unique host name of an end node that can be further mapped into an IP address), symbol type, symbol position, label, hidden value, existence of submap, parent submap, submap overlay, layout style, layout status, and other parameters similar to those employed by Hewlett Packard's Network Node Manager®. Moreover, the network map file preferably includes information regarding any source agent(s) (e.g., SNMP agent) residing on a discovered network device.

Furthermore, in one embodiment, application 140 generates a network map file for a given network and then updates the file if any changes in network topology are found during a subsequent device discovery polling period. In an alternative embodiment, application 140 generates a new map file after each discovery polling period. Moreover, in some embodiments, device discovery is performed by application 140. In another embodiment, device discovery information is imported from another application. In addition or in the alternative, network topology application 140 may perform other network administrative functions (e.g., generate intuitive graphical views of the network structure and of device status, evaluate event streams to pinpoint root causes of failure, aid in the identification of potential trouble spots before a failure occurs, provide capabilities for intelligent network administration, etc).

In the illustrated embodiment, application 140 is communicatively coupled to data sources 110-1, 110-2, and 110-n. Preferably, therefore, application 140 is also communicatively coupled to source agents 160-1, 160-2, and 160-n.

As mentioned earlier, in various embodiments, network 100 includes enhanced network usage monitoring application 120. Application 120, when operational, functions as a repository of network usage information for network 100 by gathering usage data from one or more data sources of network 100 and then storing the collected usage data. In the illustrated embodiment, application 120 is communicatively coupled to data sources 110-1, 110-2, and 110-n, as well as source agents 160-1, 160-2, and 160-n. Accordingly, application 120 may collect usage data directly from data sources 110-1, 110-2, 110-n and/or the source agents residing thereon. In a preferred embodiment, application 120 communicates with data sources 110-1, 110-2, 110-n and/or source agents 160-1, 160-2, and 160-n via SNMP or other network protocols. Preferably, monitoring application 120 processes the collected usage data in some manner (described in greater detail below) prior to, simultaneous with, and/or after storing the collected data. Furthermore, in some embodiments, application 120 correlates gathered/collected usage data with accounting/session information so that usage data can be attributed to a specific account(s) for billing purposes.

The usage data stored by application 120 may be accessible and/or provided to one or more of the earlier discussed administrative applications of network 100. In one embodiment, the stored usage data is made accessible to and/or is provided to the administration applications of network 100 via application, file-base and/or database interfaces 130. Preferably, interfaces 130 is an open interface (e.g., Common Object Request Broker Architecture (CORBA)) such that applications 140, 150-1, and 150-n may communicate with application 120 regardless of what programming language the applications were written in, what operating system the applications are running on, or where the applications reside. Furthermore, interfaces 130 preferably includes one or more application programming interfaces (APIs) that support applications 140, 150-1, and 150-n, as well as enable systems integrators and developers to extend the capabilities of application 120 to new devices, service, and applications. Moreover, in some embodiments, via interfaces 130, each of applications 120, 140, 150-1, and 150-n may save data into files that may be consumed by the other applications. In addition or in the alternative, in some embodiments, each of applications 120, 140, 150-1, and 150-n may save data into some accessible central database system such as Oracle®, Solid®, and Structured Query Language (SQL), that may be accessed by the other applications.

Preferably, application 120 includes a Graphic User Interface (GUI) enabling ease of use and administration of application 120. In one embodiment, a user is able to configure application 120 or some aspect thereof via the GUI. Moreover, through the GUI, a user preferably may view collection logs, statistics, and diagnostics; administer access privileges; view performance statistics; add, modify, and/or delete processing and/or storing rules, as well as data attributes; start and stop operations; etc.; for application 120. Furthermore, in one embodiment, application 120 can be remotely administered from a single server.

The above-described applications (e.g., network topology application 140, network application 120, source agents 160-1, 160-2, and 160-n, source databases 165-1, 165-2 and 165-n, and/or other administrative applications 150-1, and 150-n) may exist as a running process or service on a processor-based device of network 100. Preferably, one or more of the above described applications are deployed on a processor-based device having a single processor, on a processor-based device utilizing multiple processors, across multiple processor-based devices, or across any networked combination thereof.

When such running processes or services are implemented via executable instructions, various elements of the above described applications are in essence the code defining the operations of such various elements. The above described applications may be implemented in any code, now known are later developed, to include C, C++, Visual Basic, Java, XML (extensible markup language), HTML (hypertext markup language), any CORBA-integrated language, etc. Preferably, one or more of the above mentioned applications are implemented via a programming language that is device and operating system independent (e.g., Java) so that the applications are unaffected by the underlying architecture or operating system(s) of network 100.

The executable instructions or code implementations of the above described applications may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, the readable media on which the above-described applications may be stored include any medium that can store or transfer information. In one embodiment, one or more of the above described applications are distributed among a plurality of readable media (e.g., a plurality of hard drive media).

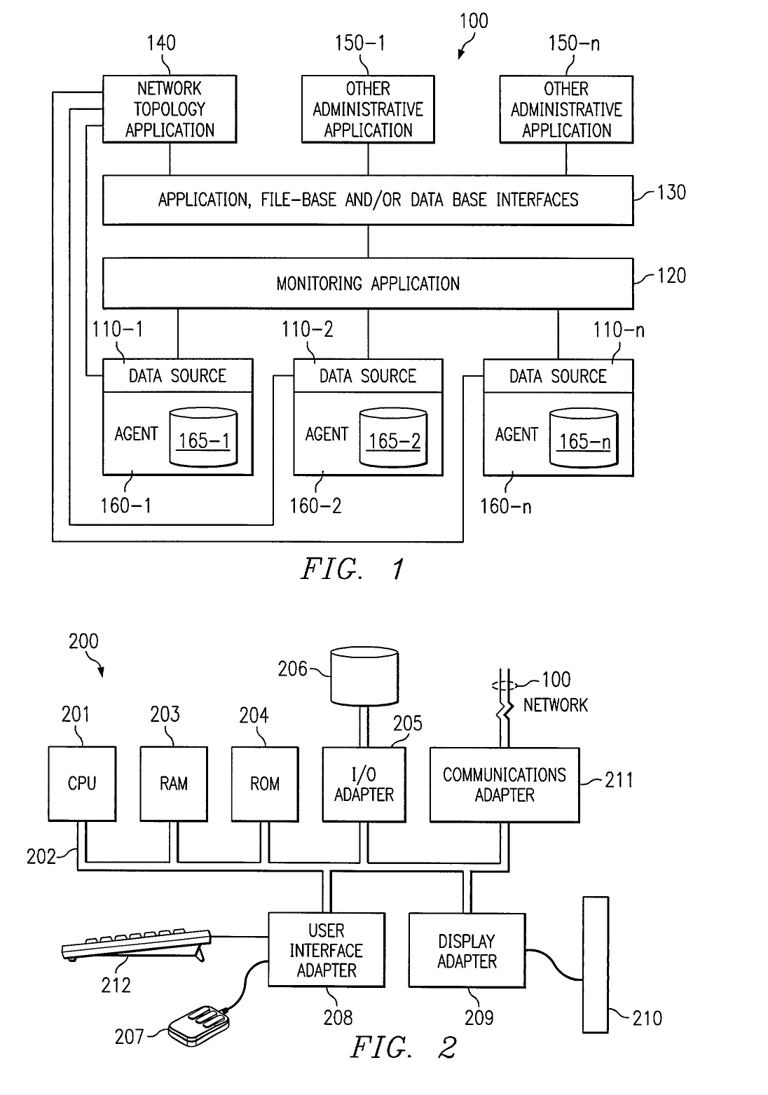

As a non-limiting example of a processor-based device that may be employed in network 100 to execute at least a portion of one or more of the above described applications, FIG. 2 depicts processor-based system 200. Various devices associated with the present invention may utilize the architecture of processor-based system 200, including but not limited to server devices, client devices, etc. System 200 includes central processing unit (CPU) 201. CPU 201 may be any general purpose CPU, such as an Intel Pentium® processor. However, the devices of network 100 that may execute the above described applications are not restricted by the architecture of CPU 201 as long as CPU 201 supports the inventive operations as described herein. In one embodiment, CPU 201 is coupled to system bus 202. Moreover, in some embodiments, processor-based system 200 also includes random access memory (RAM) 203 coupled to bus 202, which may be SRAM, DRAM, or SDRAM. Processor-based system 200 may also include ROM 204, which may be PROM, EPROM, or EEPROM, coupled to bus 202. RAM 203 and ROM 204 may hold user and system data, as well as programs, as is well known in the art. Furthermore, RAM 203 and/or ROM 204 may hold at least a portion of one or more of the above mentioned applications. In addition to or in lieu of the above, RAM 203 and/or ROM 204 may hold at least a portion of the stored usage data. Also additionally or in the alternative, RAM 203 and/or ROM 204 may hold at least a portion of the earlier described network map file.

Processor-based system 200 may also include input/output (I/O) controller adapter 205. In one embodiment, I/O controller adapter 205 communicatively couples system 200 to storage device 206. Storage device 206 may include one or more of a hard drive, CD drive, floppy disk drive, tape drive, and/or any other known data storage medium Furthermore, in one embodiment, storage device 206 contains at least a portion of one or more of the above-described applications. Moreover, in addition to or in lieu of the above, storage device 206 may contain at least a portion of the stored usage data. Furthermore, also in addition or in the alternative, storage device 206 may contain at least a portion of the earlier discussed network map file.

In some embodiments, processor-based system 200 includes communications adapter 211, user interface adapter 208, and/or display adapter 209. Communications adapter 211 may be adapted to communicatively couple processor-based system 200 to network 100 and/or some other data network (e.g., one or more of a telephone network, LAN, WAN, MAN, Ethernet network, fibre channel network, Internet, and/or the like). In addition, user interface adapter 208 may couple user input devices, such as keyboard 212 and pointing device 207, to processor-based system 200. Furthermore, display adapter 209 may be driven by CPU 201 to control the display on display device 210.

In one embodiment, processor-based system 200 is not limited to the function of executing at least a portion of one or more of the above applications. System 200 may host other applications, etc., and/or posses other functions/capabilities in addition to executing and/or hosting at least a portion of one or more of the above applications.

Returning to FIG. 1, it will be appreciated by one of ordinary skill in the art that the elements and configuration of network 100 depicted in FIG. 1 are by way of example only. Network 100 may have other configurations that have more, less and/or different elements than those depicted in FIG. 1. For example, in one embodiment, network 100 does not include one or more of administrative applications 150-1 and 150-n. Moreover, in one embodiment, in addition to or in lieu of being available to administration applications, usage data stored by application 120 is available to non- or hybrid administration applications. Furthermore, rather than being separate, interface 130 may be part of application 120.

In addition, in the illustrated embodiment, applications 120 and 140 are communicatively coupled to data sources 110-1, 110-2, and 110-n (and therefore source agents 160-1, 160-2, 160-n), while administrative applications 150-1 and 150-n are not. However, in some embodiments, applications 150-1 and 150-n are also communicatively coupled to data sources 110-1, 110-2, and 110-n (as well as source agents 160-1, 160-2, and 160-n). In one of these embodiments, applications 120, 140, 150-1 and 150-n may collect different information from data sources 110-1, 110-2, and 110-n, as well as communicate with each other via application, file-base and/or data base interfaces 130. Moreover, in some embodiments, applications 140, 150-1 and 150-n are communicatively coupled to data sources 110-1, 110-2, and 110-n, while application 120 is not. In one of these embodiments, application 120 collects information from applications 140, 150-1, and 150-n. Furthermore, in one embodiment, application 120 may collect usage data directly from data sources 110-1, 110-2, and 110-n, as well as indirectly through applications 140, 150-1, and 150-n.

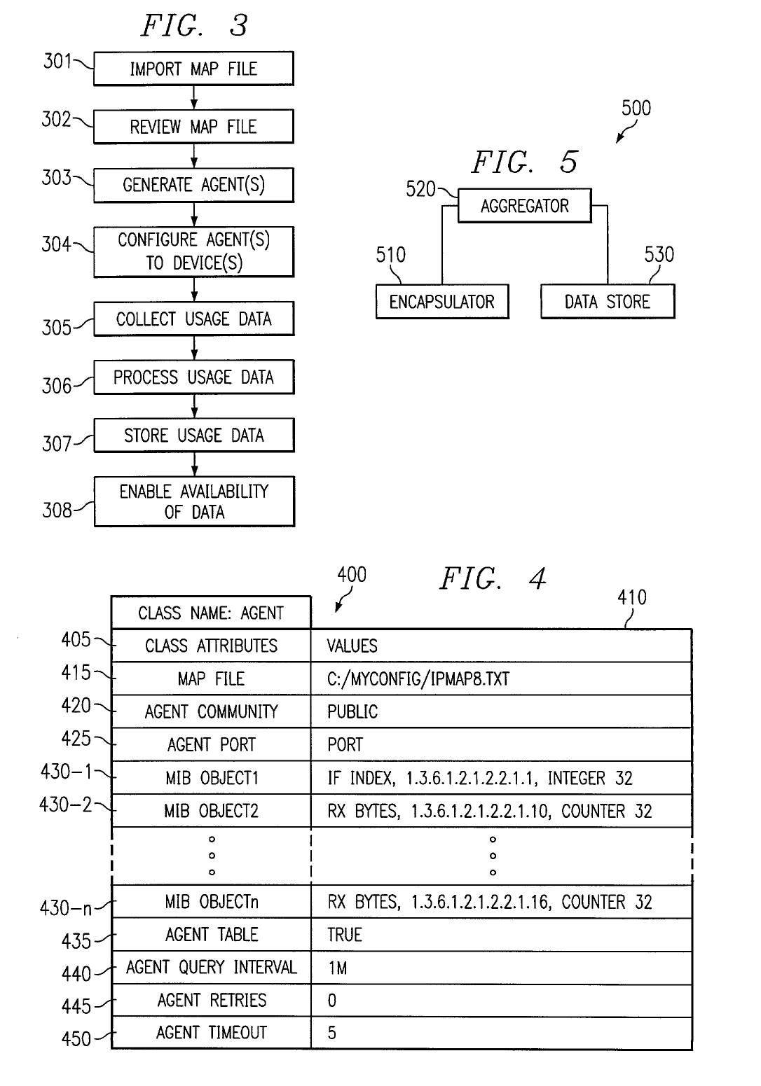

An exemplary flow diagram depicting the operation of an embodiment of monitoring application 120 is provided in FIG. 3. In the illustrated embodiment, application 120 imports or otherwise receives the current network map file stored by network topology application 140 (box 301). In some embodiments, application 120 imports the network map file in response to an instruction from a user (e.g., system administrator). In an alternative embodiment, application 120 autonomously imports the network map file. Moreover, in one embodiment, application 140 (or some other application of network 100) exports the network map file to application 120 (e.g., in response to an instruction from a user or autonomously).

After receiving the network map file, application 120 reviews the network map file to determine the nodes (e.g., network devices and/or sub-networks) of network 100, and hence, the potential usage data sources (box 302). In a preferred embodiment, application 120 determines the end node(s) in the map file by searching for a predetermined string indicating an end node, e.g., the string “Object Type 4” used by Hewlett Packard's Network Node Manager®.

Simultaneous with or after application 120 reviews the network map file, preferably, monitoring application 120 autonomously configures itself to collect usage data from one or more of the discovered data sources (i.e., one or more of the discovered network nodes) identified in the network map file. Most preferably, application 120 configures itself to collect usage data from each of the discovered data sources.

In one embodiment, application 120 accomplishes such by first generating a monitoring agent for one or more (preferably each) of the network nodes (i.e., data sources) identified in the imported network map file (box 303). In a preferred embodiment, a monitoring agent is a software module that may collect usage data from a data source or sources, process the collected data, and/or store the collected data (processed or unprocessed). The monitoring agent may be made up of one or more objects.

In this context, “objects” refers to processing structures created according to object-oriented programming principles. Those skilled in the art will appreciate that, in general, objects are programming models which generally are defined by “state” and “behavior.” In the programming implementation of an object, the state of an object is defined by its fields, which may or may not be accessible from outside of the object. An object's behavior is defined by its methods, which manipulate instance variables (data for the object) to create new state, and which also can create new objects. Typically, the object's methods are the only means by which other objects can access or alter its instance variables, with objects interacting with one another via messages. Generally, an object is defined by a class definition and an object is a particular instantiation of that class definition. Object-oriented programming techniques are utilized in many programming languages, including C++ and Java.

In some embodiments, one or more of these generated monitoring agents are ASCII Field Delimited agents, remote authentication dial-in user service (RADIUS) agents, IP Accounting agents, User Datagram Protocol (UDP) agents, JDBC Database Query agents, general packet radio service (GPRS)/Mobile agents, SNMP agents, or wireless application protocol (WAP) agents. Preferably, application 120 assigns as a name to each generated monitoring agent the IP address of the network node from which the agent is to collect usage data.

Moreover, in one embodiment, one or more of the monitoring agents generated by application 120 includes a database for storing collected (sometimes processed) usage information. In an alternative embodiment, the monitoring agents include an object or other means for directing collected (and in some instances processed) usage data to a database or databases of network 100.

Simultaneous with the generation of the monitoring agents or sometime thereafter, application 120 configures the monitoring agents to collect data from their respective network nodes (box 304). In one embodiment, this is accomplished by application 120 specifying to each monitoring agent the IP address of the network node the monitoring agent is to collect data from (preferably as gathered from the network map file) and/or permission to access the network device. Preferably, the configuration parameters for all of the monitoring agents (which may include the above IP address and permission, as well as usage data to be collected, the manner in which the data is to be processed, the database(s) to which the data is to be stored, etc.) can be specified by a user using the GUI of application 120 or a command line utility that uploads a configuration text file.

In some embodiments, an object class(es) of application 120 performs at least a portion of one or more of the steps of importing a network map file or otherwise receiving a network map file, generating a monitoring agent(s), and configuring the monitoring agent(s). In one of these embodiments, an object instance of the earlier mentioned class(es), or some combination of object instances, makes up one or more of the earlier discussed monitoring agents that may be generated by application 120. The definition of an exemplary object class (agent object class 400) for performing at least one of the earlier described steps of receiving, generating, and/or configuring is presented in FIG. 4.

In FIG. 4, the class attributes 405 with respective attribute values 410 represent a specific object instance of agent object class 400. In a preferred embodiment, each object instance of class 400 is by itself a monitoring agent. Preferably, Attribute MapFile 415 specifies the imported network map file identifying the discovered network nodes, while the remaining attributes specify the common attributes for retrieving data from the network nodes identified in the map file.

For example, attribute AgentCommunity 420 specifies the community protocol setting for the object instances' communications with the data sources or agents residing thereon. Similarly, attribute AgentPort 425 specifies the port number setting for the object instances' communications with the data sources or agents residing thereon. Attributes MIBObject 430-1, MIBObject 430-2, and MIBObject 430-n represent the one or more MIB database objects the object instances request from source databases 165-1, 165-2, and 165-n. Furthermore, attribute AgentTable 435 specifies whether the object instances are to traverse the source agents' database tables via Get and GetNext operations (where, as mentioned, “Get” is a command to retrieve information (e.g., an object or row entry) from a database table, and “GetNext” is a command to retrieve information of the next occurring row in a database table give the Object Identifier (OID) of a row). In addition, attribute AgentQueryInterval 440 specifies the time interval between successive queries by the object instances for the source database objects specified in attributes 430-1, 430-2, and 430-n. Similarly, attribute AgentRetries 445 specifies the number of retries for a particular query (if it fails). Moreover, attribute AgentTimeout 450 specifies the number of seconds before timeout. In one embodiment, all the object instances of class 400 query the same database objects, use the same protocol settings (e.g., port, community), populate the same database objects, use the same processing scheme when processing usage data, and store into the same database as specified by the class configuration.

It will be appreciated that the class definition, attributes, values, etc., depicted in FIG. 4 are by way of example only for the earlier mentioned object class may have fewer number of, greater number of, and/or different attributes than those illustrated in FIG. 4. For example, in one embodiment, class 400 includes attribute FlushAfterPoll specifying whether an object instance processes information immediately whenever available, or whether the monitoring agent object waits until a certain amount of information is gathered before processing. Moreover, the instances of object class 400 could have different values than those depicted in FIG. 4.

Moreover, similar to earlier discussions, the monitoring agents (which, in some embodiments, include databases) generated by application 120 may exist as a running process or service on a processor-based device of network 100 (e.g., processor-based system 200 of FIG. 2).

Furthermore, again, when such running processes or services are implemented via executable instructions, various elements of the above described applications are in essence the code defining the operations of such various elements. The monitoring agents may be implemented in any code, now known are later developed, to include C, C++, Visual Basic, Java, XML (extensible markup language), HTML (hypertext markup language), any CORBA-integrated language, etc. Preferably, one or more of the above mentioned monitoring agents are implemented via a programming language that is device and operating system independent so that the monitoring agents are unaffected by the underlying architecture or operating system(s) of network 100.

Similarly, the executable instructions or code implementations of the above described monitoring agents may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, the readable media on which the above described monitoring agents and/or monitoring databases may be stored include any medium that can store or transfer information. In some embodiments, RAM 203 and/or ROM 204 of system 200 hold at least a portion of one or more of the above mentioned monitoring agents (which, in some embodiments, include databases). Additionally or in the alternative, in some embodiments, storage device 206 holds at least a portion of one or more of the above mentioned monitoring agents.

Returning to FIG. 3, once application 120 is configured to collect usage data from a particular network device (e.g., a monitoring agent generated by application 120 is configured to collect data from a particular network device), application 120 begins to collect usage data from the device (box 305). In one embodiment, application 120 collects usage data from a device by reviewing device and/or application logs, e.g., device logs, HTTP (HyperText Transfer Protocol) logs, event logs, service application logs, and the like. In addition to or in lieu of the above, application 120 may collect usage data by reading data streams, such as packet or event streams. Moreover, application 120 may query a source agent residing on a network device for usage data stored at the agent's associated database (e.g., queries an SNMP agent for information from its MIB). Preferably, application 120 retrieves information from the associated database via Get, GetNext and/or GetBulk operations (e.g., SNMP-Get, GetNext, and/or GetBulk operations), where GetBulk is an operation that is used to retrieve large amounts of data from different database objects in one single command. Furthermore, in some embodiments, application 120 waits and listens for data from source agents (such as file transfer protocol (FTP) applications) through a reliable delivery-guaranteed connection. In a preferred embodiment, at least a portion of the above described collection of usage data by application 120 is performed by a monitoring agent(s) generated by application 120 (e.g., the object instances discussed earlier).

Furthermore, preferably, simultaneous with or after the collection of usage data, application 120 processes the collected data (box 306). The processing of the usage data by application 120 may include such operations as aggregation, filtering, correlation, combining, summation (e.g., summing the number of bytes sent between pairs of IP addresses), finding maxima and/or minima, merging additional data items, firing triggers or threshold alarms, and/or the like. The above mentioned filtering of the usage data may include filtering out certain usage data, as well as data from particular devices (e.g., filtering out data originating from a certain IP address or allowing only data originating from a certain IP address). Furthermore, in one embodiment, the above mentioned processing includes adornment, which, for the purposes of this disclosure, refers to modifying some data information based on certain conditions (e.g., put “XXX” into the userID if userID is null). In some embodiments, as mentioned above, application 120 correlates gathered usage information with accounting/session information so that usage information can be attributed to a specific account for billing purposes. In one embodiment, the particular processing steps performed by application 120 are user configurable. Moreover, in a preferred embodiment, at least a portion of the above discussed processing of the collected usage data is performed by a monitoring agent(s) generated by application 120 (e.g., the object instances discussed earlier). In one of these embodiments, each monitoring agent uses the same processing scheme.

As mentioned, in some embodiments, before, simultaneous with, or after the usage data is processed, the collected usage data is stored (box 307). In one embodiment, the processed usage data is stored in a format (e.g., HTML, XML, ASCII-limited records) compatible with an end-use application (e.g., applications 150-1 and 150-n). Preferably, the storage format is an open format. Preferably, the storage format, as well as the type of data stored, is user configurable. Similar to the steps of collecting and processing, in a preferred embodiment, at least a portion of the storing of usage data is performed by a monitoring agent(s) generated by application 120 (e.g., the object instances discussed earlier).

Moreover, in one embodiment, application 120 stores the usage data in a central database. In an alternative embodiment, application 120 stores the usage data via a distributed database architecture. Furthermore, as mentioned, the monitoring agents generated by application 120 may include databases. In one of these embodiments, each monitoring agent stores the usage data it collects and/or processes in its associated database. Similarly, as mentioned, the monitoring agents generated by application 120 may include an object or other means whereby the collected (and, in some instances, processed) usage data is directed to a database(s). The database(s) to which the data is directed may be a central database or one or more of a group of distributed databases.

Simultaneous with or sometime after the storage of the collected usage data, in one embodiment, the stored usage data is made available to one or more of the administrative applications of network 100 (box 308). As a non-limiting example, the stored usage data may be made available to one or more of the administrative applications by being accessible to the administrative applications and/or being provided to the administrative applications. The stored usage data may be made available to the administrative applications through file based or programmatic (e.g., application programming interface (API)) means. As mentioned earlier, preferably, the stored data is made available to the administrative applications (and/or other applications) via interfaces 130. In one embodiment, application 120 outputs the stored data to one or more of applications 140, 150, and/or 150-1 in one or more of a wide variety of configurable formats (e.g., ASCII, binary, fixed width fields, delimited fields, XML, etc.). In at least one of these embodiments, the stored data is made available in an open format.

It will be appreciated by one of ordinary skill in the art that the steps, as well as the order of the steps, shown in FIG. 3 and discussed above, are by way of example only. Steps other than those shown in FIG. 3 may be performed by application 120. Moreover, the steps may be performed in an order other than that depicted in FIG. 3. Also, fewer steps than those depicted in FIG. 3 may be performed by application 120.

Furthermore, in a preferred embodiment, one or more of the earlier mentioned monitoring agents is a collector. A block diagram of an exemplary collector is provided in FIG. 5. In the embodiment of FIG. 5, collector 500 includes encapsulator 510, aggregator 520, and data store 530. In one embodiment, each of encapsulator 510, aggregator 510, and data store 530 is a separate object. Therefore, when such collectors are generated by a single object class (e.g., class 400), the object instances of the class themselves each include encapsulator, aggregator, and data store objects.

Encapsulator 510 collects usage data from one or more network devices. Preferably, encapsulator 510 generates a stream of internal self-describing data records, which, for purposes of this disclosure, are referred to as Normalized Metered Events (NME). Preferably, an NME comprises a set of usage data attributes (e.g., the usage data information mentioned earlier, such as IP address, source address, protocol used, port numbers, start time, end time, etc). In one embodiment, the usage data included in the NMEs is collected via one or more of the earlier described means for collecting usage data (e.g., reviewing a packet stream, reviewing a log file, querying an agent database, etc.).

The usage data collected by encapsulator 510 is preferably processed by aggregator 520. In one embodiment, aggregator 520 is a rule-driven engine that processes the NME stream according to configurable aggregation rule-sets that guide aggregator 520's actions. For purposes of this disclosure, these rules sets are referred to as aggregation schemes. Preferably, each aggregation scheme comprises a list of processing rules. These rules perform one or more of the processing functions described earlier, such as filtering, summation, finding the maxima, etc. Using these schemes, the monitoring application can perform extremely flexible and dynamically reconfigurable processing. Preferably, a single aggregator can run multiple parallel aggregation schemes.

In one embodiment, the end result of the above processing by aggregator 520 is an output NME(s). Preferably, the output NME(s) is stored by collector 500 in a database(s). The database(s) in which the output NME(s) is stored may be a centralized database to which a plurality of collectors of application 120 store output NMEs. In an alternative embodiment, collector 500 stores the output NME(s) in one or more of a group of distributed databases of network 100. Preferably, such distributed database architecture enables data collection at or close to the source.

In one embodiment, data store 530 is the database(s) in which the output NME(s) is stored. In another embodiment, data store 530 is an object that may be configured to direct the output NME(s) generated by collector 500 to a centralized database or to some part of a group of distributed databases.

In addition, in one embodiment, the output NMEs are generated and/or stored in a format (e.g., HTML, XML, ASCII-limited records) compatible with an end-use application (e.g., applications 150-1 and 150-n). In some embodiments, the storage format is an open format. Preferably, the storage format is user configurable. Furthermore, in one embodiment, applications of network 100 (e.g., other administration applications 150-1 and 150-n) may query the collectors and/or databases to obtain the stored NMEs. Preferably, such queries are made via interfaces 130.

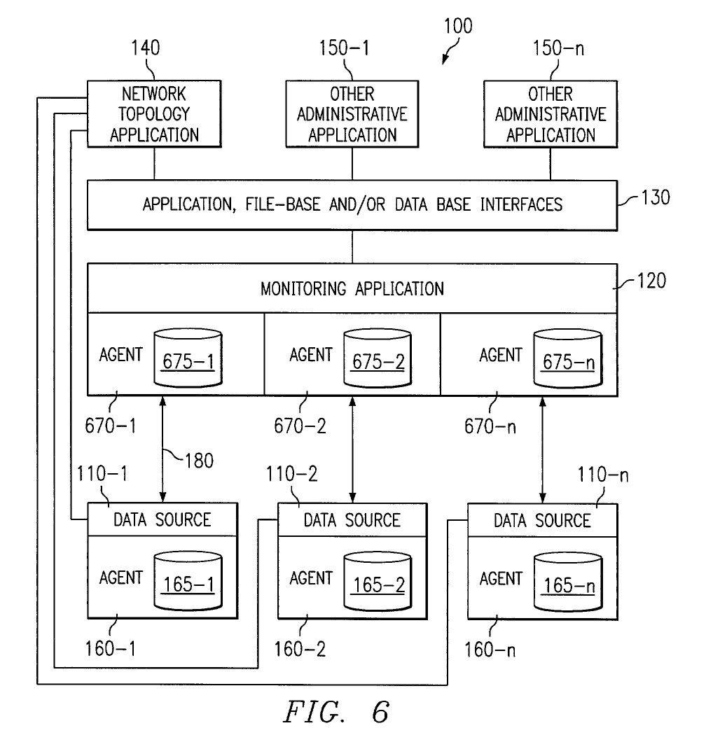

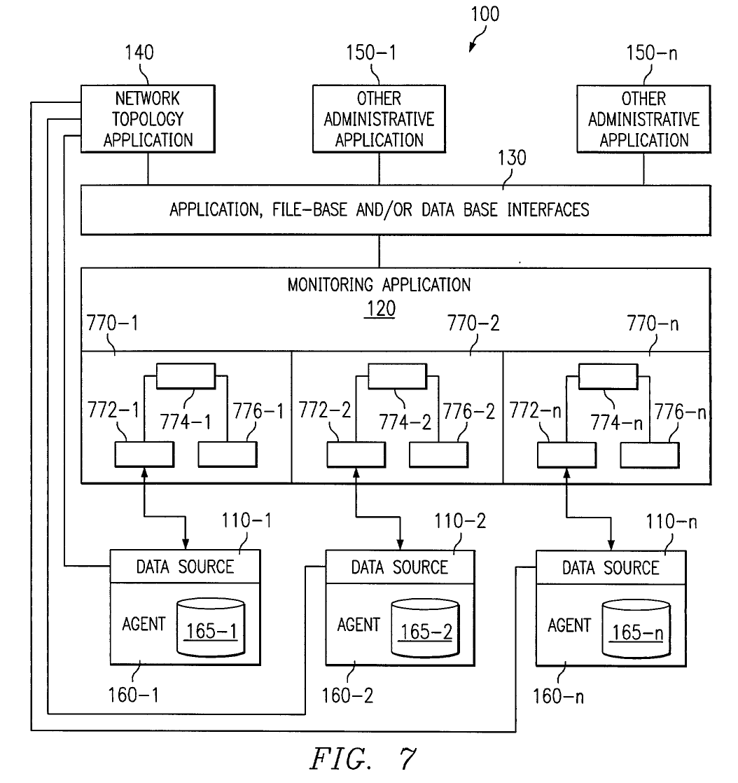

FIGS. 6 and 7 display network 100 after embodiments of application 120 have imported and/or received a network map file for network 100 from topology application 140 and configured themselves to collect usage data from data sources 110-1, 110-2, and 110-n. In the embodiment of FIG. 6, application 120 has generated and configured three agents (i.e., agents 670-1, 670-2, and 670-n). Agent 670-1 is configured to query source agent 160-1 of data source 110-1 for usage data stored at source database 165-1. Moreover, agent 670-1 is configured to store the collected usage data at storage database/object 675-1. Storage database/object 675-1 may be an actual physical database(s). However, in an alternative embodiment, it is an object operable to direct collected usage data to a physical database(s).

Similarly, agent 670-2 is configured to query source agent 160-2 of data source 110-1 for usage data stored at source database 165-2. In addition, agent 670-2 is configured to store the collected usage data at storage database/object 675-2. Like the above, storage database/object 675-2 may be an actual physical database(s). However, in an alternative embodiment, it is an object operable to direct collected usage data to a physical database(s).

Likewise, agent 670-n is configured to query source agent 160-n of data source 110-n for usage data stored at source database 165-n. Furthermore, agent 670-n is configured to store the collected usage data at storage database/object 675-n. Storage database/object 675-n may be an actual physical database(s). However, in an alternative embodiment, it is an object operable to direct collected usage data to a physical database(s). In one embodiment, one or more of agents 670-1, 670-2, and 670-n process the collected usage data prior to or simultaneous with storing it.

FIG. 7 depicts an embodiment where agents generated and configured by application 120 are collectors (e.g., collectors 770-1, 770-2, and 770-n). As can be seen, in FIG. 7, collector 770-1 includes encapsulator 772-1, aggregator 774-1, and data store 776-1. Encapsulator 772-1 is configured to query source agent 160-1 for usage data stored at source database 165-1; aggregator 774-1 is configured to process the usage data collected from source database 165-1; and data store 776-1 is where the processed usage data outputted by aggregator 774-1 is stored or directed to a database(s). Similarly, collector 770-2 includes encapsulator 772-2, aggregator 774-2, and data store 776-2. Encapsulator 772-2 is configured to query source agent 160-2 for usage data stored at source database 165-2; aggregator 774-2 is configured to process the usage data collected from source database 165-2; and data store 776-2 is where the processed usage data outputted by aggregator 774-2 is stored or directed to a database(s). Likewise, collector 770-n includes encapsulator 772-n, aggregator 774-n, and data store 776-n. Encapsulator 772-n is configured to query source agent 160-n for usage data stored at source database 165-n; aggregator 774-n is configured to process the usage data collected from source database 165-n; and data store 776-n is where the processed usage data outputted by aggregator 774-n is stored or directed to a database(s).

It will be appreciated by one of ordinary skill in the art that the configurations depicted in FIGS. 6 and 7 are by way of example only, for network 100 may have several configurations after application 120 is configured to collect usage data from the data source of network 100. For example, in one embodiment, the agents might be organized as a hierarchy of agents each with a number of sub-agents. They agents and sub-agents may work in concert as a pipelined, distributed aggregation engine. Moreover, in one embodiment, each level in the hierarchy performs only a portion of the processing, aggregating down the data before passing it on for further processing higher up. Eventually the usage data is so reduced as to allow an existing end application (e.g., other administration applications 150-1 and 150-n) to be able to process the data.

In addition, although in some of the above discussions, application 120 generates a plurality of monitoring agents whereby each agent is responsible for a particular data source, in one embodiment, application 120 generates a single agent that is operable to collect usage data from a plurality of data sources (preferably all of the data sources) of network 100.

Furthermore, in one embodiment, each time a new network map file is generated by application 140 and/or each time an existing network map file is updated by application 140 (e.g., in response to the discovery of a new network device and/or the discovery of the removal of an old network device), a user of application 120 (e.g., system administrator) instructs application 120 to import the new or updated map file. In an alternative embodiment, a user of application 140 instructs application 140 to export the new or updated map file to application 120. In yet another embodiment, application 140 autonomously exports the network map file each time a new network map file is generated and/or an existing network map file is updated. In still yet another embodiment, application 120 autonomously imports the most current network map file whenever application 140, or another application, indicates a change in an existing network map file has been made or a new network map file has been generated.

In some embodiments, when an updated or new network map file is received, application 120 reconfigures itself to collect usage data from one or more of the network nodes identified in the current network map file. In one embodiment, this involves generating one or more additional agents to collect, process, and/or store usage data from any newly discovered nodes. Moreover, in some embodiments, this involves deleting one or more agents configured to collect, process, and/or store usage data from network nodes since removed from network 100. However, in an alternative embodiment, regardless of whether a new node (e.g., a new device or sub-network) was added, a previous node was removed, or a combination of both, application 120 deletes all agents previously generated by application 120 and then generates new agents for all of the network nodes listed in the current map file. As mentioned earlier, in one embodiment, application 120 generates a single agent for all of the network nodes listed in the current map file.

Various embodiments of the present invention alleviate the problems existing in the prior art. For example, in one embodiment, the enhanced network usage monitoring system of the present invention is operable to configure itself to collect usage data from the usage data sources of a network. As a result, users (e.g., system administrators) no longer need to engage in the time consuming and burdensome process of configuring a usage monitoring system to each usage data source the user desires the monitoring system to collect usage data from.

What is claimed is:

1. A computer program product having a computer readable medium having computer program logic recorded thereon for the collection of usage data from at least one node of a network, the computer program product comprising:
code for receiving data from an administrative application, wherein said data identifies at least one node of a network;
code for configuring said computer program product to collect usage data from at least one of the at least one identified network node.

2. The computer program product of claim 1 wherein said computer readable medium further includes:
code for collecting usage data from said at least one of the at least one identified network node;
code for processing the collected usage data; and
code for storing the processed usage data.

3. The computer program product of claim 2 wherein said code for collecting said usage data includes code for reading data streams.

4. The computer program product of claim 2 wherein said code for processing includes code for performing a processing step selected from the group consisting of filtering, summation, finding maxima, finding minima, and adornment.

5. The computer program product of claim 2 wherein said code for storing includes storing the processed usage data in an open format.

6. The computer program product of claim 1 wherein said code for configuring said computer program product includes:
code for generating at least one agent operable to collect usage data from said at least one of the at least one identified network node; and
code for configuring said at least one agent to collect usage data from said at least one of the at least one identified network node.

7. The computer program product of claim 6 wherein said at least one agent includes at least one collector.

8. The computer program product of claim 1 wherein said code for configuring said computer program product includes:
code for generating one agent operable to collect usage data from said at least one of the at least one identified network node; and
code for configuring said one agent to collect usage data from said at least one of the at least one identified network node.

9. The computer program product of claim 1 wherein said code for configuring includes code for specifying an IP address of said at least one of the at least one identified network node, as well as permission to access said at least one of the at least one identified network node.

10. The computer program product of claim 1 wherein said code for configuring said computer program product includes:
code for configuring said computer program product to collect usage data from a database of an agent residing on said at least one of the at least one identified network node.

11. The computer program product of claim 10 wherein said agent comprises a simple network management protocol (SNMP) agent and said database comprises a management information base (MIB).

12. The computer program product of claim 1 wherein said code for configuring said computer program product includes an agent object class.

13. A system for the collection of usage data from at least one node of a network, said system comprising:
means for generating data identifying at least one node of a network; and
means for collecting usage data from at least one of the at least one identified network node, wherein the usage data collection means includes:
means for receiving the identifying data from said generating means; and
means for configuring the usage data collection means to collect usage data from said at least one of the at least one identified network node.

14. The system of claim 13 wherein the usage data collection means further includes:
means for processing usage data collected from said at least one of the at least one identified network node; and
means for storing the processed usage data.

15. The system of claim 14 wherein the usage data collection means further includes:
means for making the stored data available to at least one administration application of said system.

16. The system of claim 13 wherein the usage data collection means includes:
means for generating at least one agent means for collecting usage data from said at least one of the at least one identified network node; and
means for configuring said at least one agent means to collect usage data from said at least one of the at least one identified network node.

17. The system of claim 13 wherein the usage data collection means includes:
means for collecting usage data from a database of an agent residing on said at least one of the at least one identified network node.

18. A method for the collection of usage data from at least one node of a network, the method comprising:
receiving data identifying at least one node of a network from an administrative application; and
configuring a usage data application to collect usage data from at least one of the at least one identified network node.

19. The method of claim 18 wherein said configuring includes:
generating at least one agent operable to collect usage data from said at least one of the at least one identified network node; and
configuring said at least one agent to collect usage data from said at least one of the at least one identified network node.

20. The method of claim 18 wherein said configuring includes:
configuring said usage data application to collect usage data from a database of an agent residing on said at least one of the at least one identified network node.
